(19) United States
(12) Patent Application Publication
(10) Pub. No.: US 2020/0348950 A1
(43) Pub. Date: Nov. 5, 2020

(54) DATA PROCESSING APPARATUSES AND METHODS

(71) Applicant: Sony Corporation, Tokyo (JP)

(72) Inventors: Nigel Stuart MOORE, Basingstoke (GB); Alexei KARPOV, Basingstoke (GB)

(73) Assignee: Sony Corporation, Tokyo (JP)

(21) Appl. No.: 16/642,925

(22) PCT Filed: Aug. 16, 2018
(86) PCT No.: PCT/GB2018/052320

§ 371 Date: Feb. 28, 2020

(30) Foreign Application Priority Data
Jul. 9, 2017 (GB) 1714388.4

(51) Int. Cl. G06F 9/451; G06N 5/02; G06F 3/0482; G06F 3/0484

(52) U.S. Cl. CPC G06F 9/451; G06F 3/04847; G06F 3/0482; G06N 5/022

(57) ABSTRACT

A data processing apparatus comprising processor circuitry, the processor circuitry being configured: to determine whether a decision associated with a process executable by the processor circuitry is to be made; in response to determining that the decision is to be made, to determine one of a plurality of predetermined actions to be executed based on a previously indicated action executable in response to the decision to be made at the data processing apparatus or at one or more other data processing apparatuses connected to the data processing apparatus; and to execute the determined predetermined action.

### BACKGROUND

### Field of the Disclosure

The present disclosure relates to data processing apparatuses and methods.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Electronic data processing apparatuses/devices (such as, for example, personal computers, televisions, mobile phones, tablet computers or the like) are sometimes required to receive input from a user regarding whether or not to execute a particular process. This is normally implemented by displaying a dialogue box to a user with a question and with a plurality of predetermined selectable options. The user then selects an appropriate one of the selectable options and further processing carried out by the electronic device is then carried out on the basis of the selected option.

An example of such a dialogue box is given in FIG. 1. Here, a dialogue box 113 with the question “This encrypted connection is trying to use a weak cipher using RC4 with MD5. Do you want to accept?” is displayed on the screen 112 of a television (TV) 100 (in this case, a smart TV with internet connectivity). Such a message may be displayed when, for example, the user wishes to access a certain internet server for downloading media content. Using a remote control (not shown), the user may then select “Yes” in order to allow the connection to be established by selecting the “Yes” virtual button 114A or “No” in order to block the connection from being established by selecting the “No” virtual button 114B. The user may also select the “Advanced” virtual button which results in a further dialogue box (not shown) being displayed which gives further information and/or options relating to the question asked.

A problem with such questions being presented to the user, however, is that the content of such questions can be very technical and difficult to understand for end users of electronic devices such as smart TVs to use. The question in the dialogue box shown in FIG. 1 is an example of such a question. That is, many end users who, for example, purchase a smart TV in order to enjoy media content will not have technical understanding of what a “cipher using RC4 with MD5” is. It is therefore difficult for the user to make an informed decision as to permit the process mentioned in the dialogue box to be executed.

The user may look up one or more of the terms mentioned in the dialogue box (e.g. using the internet). However, this is time consuming and, furthermore, there is no guarantee that the user will be able to understand the technical details relating to the content of the dialogue box even if they do manage to find an explanation of those technical details. As a result of this, it is common for users to simply choose an answer without fully appreciating the consequences of that answer. For example, with the dialogue box of FIG. 1, a user may simply select the “Yes” option so as to enable the connection with a media content server to be established, even though enabling such a connection may present a security risk to the user (for example, a man in the middle attack may become plausible, which could be used to obtain information about the content that a user is viewing). Dialogue boxes such as the dialogue box 113 shown in FIG. 1 can therefore be of limited effect in improving the security of a user. They also interrupt a task that a user is wishing to undertake using the electronic device concerned, thus negatively affecting the user's experience.

There is a need to try to alleviate these problems.

### SUMMARY

The present technique provides a data processing apparatus comprising processor circuitry, the processor circuitry being configured: to determine whether a decision associated with a process executable by the processor circuitry is to be made; in response to determining that the decision is to be made, to determine one of a plurality of predetermined actions to be executed based on a previously indicated action executable in response to the decision to be made at the data processing apparatus or at one or more other data processing apparatuses connected to the data processing apparatus; and to execute the determined predetermined action.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically shows a dialogue box displayed on the screen of a data processing apparatus in the case that a decision associated with a process executable by the data processing apparatus is to be made.

FIG. 2 schematically shows a plurality of data processing apparatuses.

FIG. 3 schematically shows the dialogue box of FIG. 1 in which a recommendation is made to a user.

FIG. 4 schematically shows a screen for selecting one of a plurality of options each corresponding to a respective one of a plurality of predetermined actions to be carried out by a data processing apparatus in response to a decision to be made.

FIG. 5 shows a flow chart schematically illustrating a method of operating a first data processing apparatus.

FIG. 6 shows a flow chart schematically illustrating a method of operating a second data processing apparatus.

FIG. 7 shows a flow chart schematically illustrating a method of operating a third data processing apparatus.

### DESCRIPTION OF THE EMBODIMENTS

Referring now to the drawings, wherein like reference numerals designate identical or corresponding parts throughout the several views.

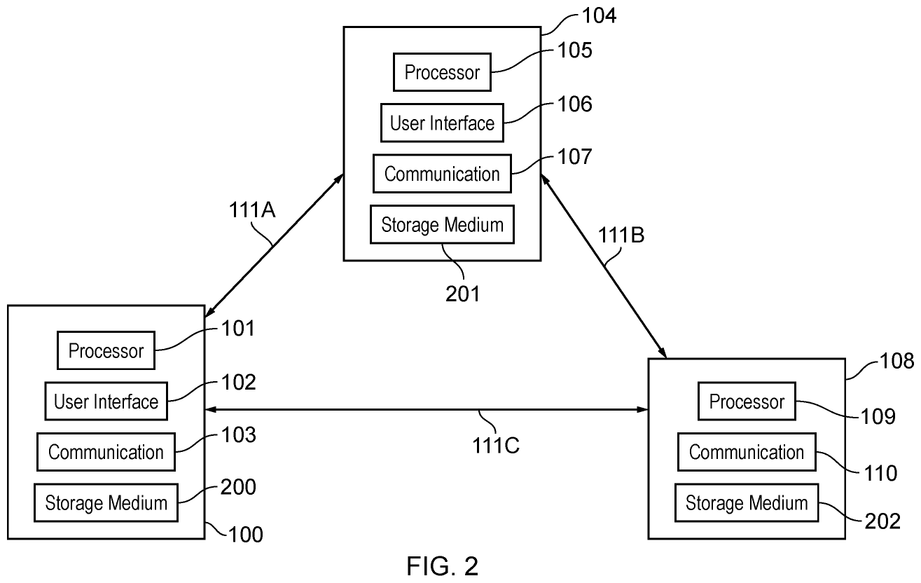

FIG. 2 shows a plurality of data processing apparatuses 100, 104 and 108.

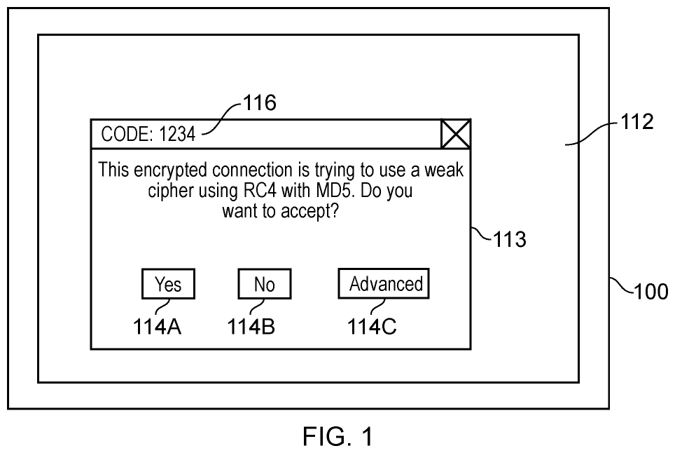

A first data processing device 100 is a data processing device such as a TV which is able to display dialogue boxes containing questions to a user. In the described embodiments, the data processing device 100 is a TV. However, it will be appreciated that the data processing device 100 may be any other data processing device which is able to provide information to a user indicative of a decision associated with a process executable by the data processing device to be made (such as the decision of whether or not to accept a connection with a “weak cipher using RC4 with MD5” in the example of FIG. 1) and which is able to receive an input from the user indicative of an action to be taken in response to the decision to be made (such as a “Yes” command or “No” command in the example of FIG. 1). The data processing device 100 comprises a processor 101, user interface circuitry 102, communication circuitry 103 and a storage medium 200. The user interface circuitry 102, communication circuitry 103 and storage medium 200 are controlled by the processor 101. The storage medium 200 may comprise a hard disk drive (HDD), solid state drive (SSD) or similar for storage of electronic data.

The processor 101 may comprise various sub-units for providing functionality in accordance with embodiments of the present disclosure as explained further herein. These sub-units may be implemented as discrete hardware elements or as appropriately configured functions of the processor 101. Thus the processor 101 may be suitably configured/programmed to provide the desired functionality described herein using conventional programming/configuration techniques. The processor 101, user interface circuitry 102, communication circuitry 103 and storage medium 200 are schematically shown in FIG. 2 as separate elements for ease of representation. However, it will be appreciated that the functionality of these components can be provided in various different ways, for example using a single suitably programmed general purpose computer, or suitably configured application-specific integrated circuit(s)/circuitry. It will be appreciated the data processing apparatus 100 will in general comprise various other elements associated with its operating functionality, but these are not shown in FIG. 2 in the interests of simplicity.

Also shown in FIG. 2 is a second data processing device 104 and a third data processing device 108, various functions of which are explained below.

The second data processing device 104 comprises a processor 105, user interface circuitry 106, communication circuitry 107 and a storage medium 201. The user interface circuitry 106, communication circuitry 107 and a storage medium 201 are controlled by the processor 105. The storage medium 201 may comprise a hard disk drive (HDD), solid state drive (SSD) or similar for storage of electronic data. The processor 105 may comprise various sub-units for providing functionality in accordance with embodiments of the present disclosure as explained further herein. These sub-units may be implemented as discrete hardware elements or as appropriately configured functions of the processor 105. Thus the processor 105 may be suitably configured/programmed to provide the desired functionality described herein using conventional programming/configuration techniques. The processor 105, user interface circuitry 106, communication circuitry 107 and storage medium 201 are schematically shown in FIG. 2 as separate elements for ease of representation. However, it will be appreciated that the functionality of these components can be provided in various different ways, for example using a single suitably programmed general purpose computer, or suitably configured application-specific integrated circuit(s)/circuitry. It will be appreciated the data processing apparatus 104 will in general comprise various other elements associated with its operating functionality, but these are not shown in FIG. 2 in the interests of simplicity.

The third data processing device 108 comprises a processor 109, communication circuitry 110 and a storage medium 202. The communication circuitry 110 and storage medium 202 are controlled by the processor 109. The storage medium 202 may comprise a hard disk drive (HDD), solid state drive (SSD) or similar for storage of electronic data. The processor 109 may comprise various sub-units for providing functionality in accordance with embodiments of the present disclosure as explained further herein. These sub-units may be implemented as discrete hardware elements or as appropriately configured functions of the processor 109. Thus the processor 109 may be suitably configured/programmed to provide the desired functionality described herein using conventional programming/configuration techniques. The processor 109, communication circuitry 110 and storage medium 202 are schematically shown in FIG. 2 as separate elements for ease of representation. However, it will be appreciated that the functionality of these components can be provided in various different ways, for example using a single suitably programmed general purpose computer, or suitably configured application-specific integrated circuit(s)/circuitry. It will be appreciated the data processing apparatus 108 will in general comprise various other elements associated with its operating functionality, but these are not shown in FIG. 2 in the interests of simplicity.

The communication circuitry 103, 107 and 110 of the respective data processing devices 100, 104 and 108 allow each of the data processing devices 100, 104 and 108 to communicate with each of one or more of the other data processing devices 100, 104 and 108. In the example of FIG. 2, each of the data processing devices 100, 104 and 108 is able to communicate with each of the other data processing devices 100, 104 and 108, as schematically illustrated by arrows 111A, 111B and 111C. This communication may occur via an electronic communication network such as the internet or a local area network (LAN). Each of the communication circuitry 103, 107 and 110 may allow wired and/or wireless communication.

It is noted that, although each of the data processing devices 100, 104 and 108 are illustrated as separate devices, the functionality of each device may be combined with that of one or more of the other devices so that the number of individual devices is reduced. For example, the second and third data processing devices 104 and 108 may, in fact, be the same device such that the described functionality of the second and third data processing devices 104 and 108 is carried out by a single physical device. In another example, the first and third data processing devices 100 and 108 may, in fact, be the same device such that the described functionality of the first and third data processing devices 100 and 108 is carried out by a single physical device.

Regarding the data processing device 100, in an embodiment, the processor 101 is configured to determine whether a decision associated with a process executable by the processor circuitry is to be made. In the example of FIG. 1, the decision would be whether or not to accept a connection using a weak cipher using RC4 with MD5. In response to determining that the decision is to be made, the processor 101 determines one of a plurality of predetermined actions to be executed based on a previously indicated action to be taken in response to the decision to be made by a user at the data processing apparatus 100 or at one or more other data processing apparatuses 104 connected to the data processing apparatus. The processor 101 then executes the determined predetermined action.

In an embodiment, the plurality of predetermined actions comprises one or more of a first action, a second action, a third action and a fourth action.

The first action comprises selecting a first one of a plurality of predetermined selectable options in order to make the decision to be made. Thus, in the example of FIG. 1, the first action may comprise selecting that the connection using a weak cipher using RC4 with MD5 should not be accepted by selecting “No” from the plurality of predetermined selectable options “Yes” and “No”. This selection occurs automatically, that is, without input from a user of the data processing apparatus 100 being required.

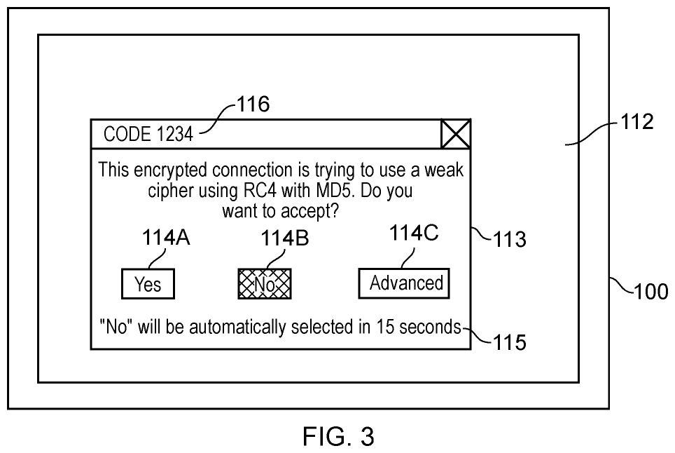

The second action comprises indicating to a user of the data processing apparatus 100 that the first one of the plurality of selectable options is recommended for selection by the user in order to make the decision to be made. Thus, in the example of FIG. 1, the second action may comprise recommending to the user to select the “No” virtual button 114B in the dialogue box 113 so as to not accept the connection using a weak cipher using RC4 with MD5. As shown in FIG. 3, which again shows the dialogue box 113 displayed on the screen 112 of a TV as the data processing apparatus 100, this recommendation may be made by visually distinguishing the “No” virtual button 114B from the “Yes” virtual button 114A in such a way that the user is able to recognise that it is the “No” option which is being recommended. In this case, the “No” virtual button 114B is distinguished from the “Yes” virtual button 114A by shading. However, it will be appreciated that any suitable method of distinguishing the “No” virtual button from the “Yes” virtual button may be used, such as displaying the “No” virtual button in a different colour to that of the “Yes” button (and the colour of the rest of the dialogue box), making the “No” virtual button appear larger than the “Yes” virtual button, or surrounding the “No” virtual button (but not the “Yes” virtual button) with a border or the like. With the second action, it is noted that the “No” option is not automatically selected without input from the user. Rather, the “No” option is recommended for selection by the user (by visually distinguishing the “No” button from the “Yes” button), but the ultimate decision of whether or not to accept the connection using a weak cipher using RC4 with MD5 is made by the user (by selecting either the “Yes” or “No” virtual button in the dialogue box 113).

The third action comprises indicating to the user of the data processing apparatus 100 that a second one of the plurality of selectable options is recommended for selection by the user in order to make the decision to be made. Thus, in the example of FIG. 1, the third action may comprise recommending to the user to select the “Yes” virtual button 114A in the dialogue box 113 so as to accept the connection using a weak cipher using RC4 with MD5. This recommendation may be made by visually distinguishing the “Yes” virtual button 114A from the “No” virtual button 114B in such a way that the user is able to recognise that it is the “Yes” option which is being recommended. Again, it will be appreciated that any suitable method of distinguishing the “Yes” virtual button from the “No” virtual button may be used, such as different shading for the “No” and “Yes” virtual buttons, displaying the “Yes” virtual button in a different colour to that of the “No” button (and the colour of the rest of the dialogue box), making the “Yes” virtual button appear larger than the “No” virtual button, or surrounding the “Yes” virtual button (but not the “No” virtual button) with a border or the like. With the third action, it is noted that the “Yes” option is not automatically selected without input from the user. Rather, the “Yes” option is recommended for selection by the user (by visually distinguishing the “Yes” button from the “No” button), but the ultimate decision of whether or not to accept the connection using a weak cipher using RC4 with MD5 is made by the user (by selecting either the “Yes” or “No” virtual button in the dialogue box 113).

The fourth action comprises selecting the second one of the plurality of predetermined selectable options in order to make the decision to be made. Thus, in the example of FIG. 1, the fourth action may comprise selecting that the connection using a weak cipher using RC4 with MD5 should be accepted by selecting “Yes” from the plurality of predetermined selectable options “Yes” and “No”. Like the first action, this selection occurs automatically, that is, without input from a user of the data processing apparatus 100 being required.

Although, in the above-described second and third actions, a plurality of selectable predetermined options (“Yes” or “No” in FIG. 1) are displayed such that a recommended one of those options is visually distinguishable from the other options, it will be appreciated that such an arrangement may be suitably adjusted depending on the way in which the plurality of selectable predetermined options are provided to a user of the data processing apparatus 100 (as explained below).

Information indicative of the plurality of selectable predetermined options is provided by the user interface circuitry 102 of the data processing apparatus 100. The user interface circuitry 102 allows information to be provided to a user of the data processing apparatus 100 and/or the user of the data processing apparatus 100 to provide an input command to the data processing apparatus 100 (in particular, an input command to the processor 101). In the example of FIG. 3, the user interface circuitry 102 controls the screen 112 of the data processing apparatus (TV) 100 to display information indicative of the decision to be made (that is, the question “This connection is trying to use a weak cipher using RC4 with MD5. Do you want to accept?”) and information indicative of the plurality of selectable predetermined options visually and controls a receiver (such as an infra-red (IR) receiver—not shown) to receive an input command from a remote control operated by the user indicating a selected one of the plurality of predetermined options. Thus, when the second or third action is executed by the processor 101, the recommended option is visually distinguished from the other options.

In another example, however, the user interface circuitry may control a loudspeaker (not shown) of the data processing apparatus (TV) 100 to provide audio information indicative of the decision to be made (for example, the question “This connection is trying to use a weak cipher using RC4 with MD5. Do you want to accept?” could be output as an audio signal to the user via a suitable text-to-speech converter, such converters being known in the art) and audio information indicative of the recommended one of the plurality of selectable predetermined options (for example, by outputting a recorded audio speech signal saying “The recommendation is to select “Yes”). The user interface circuitry may then control a microphone (not shown) of the data processing apparatus 100 to receive an oral input command from the user (for example, the user saying “Yes” or “No” aloud) indicating a selected one of the plurality of predetermined options. In this case, the input oral command may be subject to speech recognition processing (as known in the art) by the user interface circuitry in order for the input command to be recognised. Such an arrangement may useful, for example, for visually impaired users or for applications (e.g. industrial or medical applications) in which a user is not able to stop what they are doing in order to look at a screen or input commands into a remote control.

It will be appreciated that the user interface circuitry may allow information indicative of the decision to be made and information indicative of the recommended one of the plurality of selectable predetermined options to be provided and allow an input command indicating a selected one of the plurality of predetermined options to be received from a user in any suitable way.

It will be appreciated that, in the above-mentioned example, there are four predetermined actions (automatic “No”, recommended “No”, recommended “Yes” and automatic “Yes”), with “Yes” and “No” being the two predetermined selectable options. It will be appreciated, however, that the present technique may be applied for a different number of predetermined actions and predetermined selectable options. For example, there maybe three predetermined selectable options (“option 1”, “option 2” and “option 3”) and six predetermined actions (automatic “option 1”, recommended “option 1”, automatic “option 2”, recommended “option 2”, automatic “option 3” and recommended “option 3”). It will be appreciated that the present technique may be applied to any suitable combination of predetermined actions and predetermined selectable options.

In an embodiment, the second action may further comprise determining whether the user has selected one of the plurality of predetermined selectable options within a first predetermined time period and, when the user has not selected one of the plurality of predetermined selectable options with the first predetermined time period, selecting the first one of the plurality of predetermined selectable options in order to make the decision to be made. For example, in the embodiment of FIG. 3, the recommended “No” option may be automatically selected in the case that the user does not select either “Yes”, “No” or “Advanced” within the first predetermined time period. Here, the first predetermined time period is 15 seconds and this is shown as a countdown message 115 in the dialogue box 113. The countdown message informs the user that the “No” option will be automatically selected in 15 seconds. The countdown message 115 may be a live-type message which updates every second (for example) so as to read “14 seconds”, “13 seconds”, . . . , “1 second”. After the final second has elapsed, the “No” option is automatically selected.

Similarly, in an embodiment, the third action may further comprise determining whether the user has selected one of the plurality of predetermined selectable options within a second predetermined time period and, when the user has not selected one of the plurality of predetermined selectable options with the second predetermined time period, selecting the second one of the plurality of predetermined selectable options in order to make the decision to be made. For example, in the embodiment of FIG. 3, the recommended “Yes” option may be automatically selected in the case that the user does not select either “Yes”, “No” or “Advanced” within the second predetermined time period. A similar countdown message (not shown) to that shown in FIG. 3 for the “No” option may be shown which informs the user that the “Yes” option will be automatically selected in 15 seconds. The countdown message may again be a live-type message which updates every second (for example) so as to read “14 seconds”, “13 seconds”, . . . , “1 second”. After the final second has elapsed, the “Yes” option is automatically selected.

The automatic selection of the recommended option after a certain time period has elapsed helps to take the stress of making a decision away and helps to provide a more seamless user experience. It will be appreciated that the first and second predetermined time periods may be the same (as in the example above in which they are both 15 seconds) or may be different. The first and/or second predetermined time periods may be adjusted depending on the value of a predetermined parameter on the basis of which the predetermined action to be executed by the processor 101 of the data processing apparatus 100 is determined (see below).

In embodiments, a dialogue box 113 showing a recommended “No” or “Yes” option may be accompanied with an appropriate message. For example, the recommended “No” option may be accompanied with a message reading “For security reasons, we recommended selecting “No” for this decision”. The recommended “Yes” option may then be accompanied with a message reading “The risk associated with selecting “Yes” for this decision is low”.

The one of the plurality of predetermined actions (which may include one or more of the first, second, third and fourth actions mentioned above) to be executed by the processor 101 is determined based on a previously indicated action executable in response to the decision to be made. The previously indicated action may have been indicated at the data processing apparatus 100 itself or at another data processing apparatus such as data processing apparatus 104.

In one example, the predetermined action is determined by the processor 101 based on a previous action indicated in response to the decision to be made at the data processing device 100. For example, the processor 101 may control the storage medium 200 of the data processing device 100 to store an electronic file comprising a record of previous actions taken by the user in response to the decision when that decision was made at a point in the past. Thus, to use the example of FIG. 3, in the case that the question “The connection is trying to use a weak cipher using RC4 with MD5. Do you want to accept?” was asked in the past and the user selected the “Yes” option, information recording the selection of the “Yes” option for the question is stored as part of an electronic file in the storage medium 201. In this case, the selection of the “Yes” option is the previously indicated action. When the same message is displayed at a later point, the processor 101 looks up the electronic file for previous answers to the question. The record indicating that the “Yes” option was previously selected will therefore be found. The processor then determines the predetermined action to be taken for the current message based on the fact that the “Yes” option has been found. In one example, the processor 101 may execute the fourth action of automatically selecting the “Yes” option for the current message. In another example, the processor 101 may execute the third action of recommending selection of the “Yes” option to the user. Thus, in this case, the processor 101 determines the predetermined action based on a previous action indicated by a user of the data processing device 100 at the data processing device.

In another example, the predetermined action is determined by the processor 101 based on a previously indicated action executable in response to the decision to be made at another data processing device, such as data processing apparatus 104. The data processing device 104 may be, for example, an end-user type data processing device like the data processing device 100 or data processing device controlled by a service provider. The term “service provider” should be understood to mean any party which provides a centralised service for indicating the predetermined action to be taken in response to a particular decision needing to be made. The service provider may be, for example, the manufacturer of the data processing device 100 (such as a TV manufacturer), a provider of content to the data processing device 100 or an internet service provider (ISP) used by the data processing device 100 in accessing the internet.

In the case in, which the data processing device 104 is an end-user type data processing device like the data processing device 100, decisions such as that presented in FIG. 3 for the data processing device 100 will also have to be made for the data processing device 104. A decision made at the data processing device 104 may thus be used to influence which of the predetermined actions is to be executed when that same decision is presented at the data processing device 100. Thus, to use the example of FIG. 3, in the case that the question “The connection is trying to use a weak cipher using RC4 with MD5. Do you want to accept?” was asked in the past at the data processing device 104 and the user of the data processing device 104 selected the “Yes” option, information indicating the selection of the “Yes” option for the question is stored by the processor 105 as a part of an electronic file in the storage medium 201 of the data processing apparatus 104. The information indicating the selection of the “Yes” option may then be transmitted to the data processing apparatus 100 via the communication circuitry 107 and stored as part of an electronic file in the storage medium 200 of the data processing apparatus 100. In this case, the selection of the “Yes” option at the data processing apparatus 104 is the previously indicated action. When the same message is displayed at a later point at the data processing apparatus 100, the processor 101 looks up the electronic file for previous answers to the question made at the data processing apparatus 104. The record indicating that the “Yes” option was previously selected at the data processing apparatus 104 will therefore be found. The processor 101 then determines the predetermined action to be taken for the current message based on the fact that the “Yes” option has been found. In one example, the processor 101 may execute the fourth action of automatically selecting the “Yes” option for the current message. In another example, the processor 101 may execute the third action of recommending selection of the “Yes” option to the user. Thus, in this case, the processor 101 determines the predetermined action based on a previous action indicated by a user of another data processing device such as data processing apparatus 104.

In embodiments, in the case in which the data processing device 104 is an end-user type data processing device like the data processing device 100, information indicating the selection of a particular option may only be recorded a predetermined number of times within a given time period (for example, ten times per 24 hour period). Such an arrangement helps to prevent malicious attacks by users of data processing devices 104 in selecting an inappropriate option in order to skew the recommended/automatic options implemented by the data processing device 100 towards than inappropriate option.

In the case in which the data processing apparatus 104 is a data processing apparatus controlled by a service provider, the same process as described above may be carried out. However, in this case, the indicated action made at the data processing apparatus 104 is not necessarily indicated as part of a decision making process (that is, in response to the decision indicated by dialogue box 113 needing to be made at the data processing apparatus 104, for example). Rather, the indicated action may be a direct indication of which of the predetermined actions (which could include one or more of the above-described first, second, third and fourth actions) should be taken at the data processing apparatus 100 in the case of a particular decision needing to be made at the data processing apparatus 100. Such an arrangement may also be applied when the data processing apparatuses 100 and 104 are comprised within the same local network (such as a Local Area Network (LAN)) and when the data processing apparatus 104 is operated or controlled by a system administrator of the local network, for example.

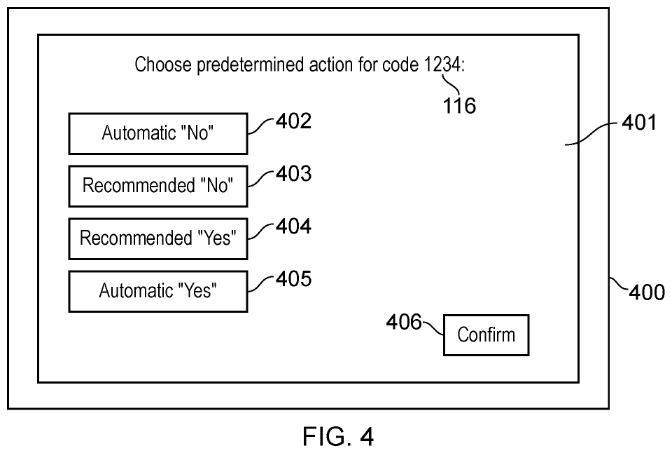

An example of such an arrangement is given in FIG. 4, which shows a display device 400 (such as a computer monitor) with a display 401 on which a predetermined action selection screen is displayed. The images displayed on the display 401 are controlled by the user interface circuitry 106 of the data processing apparatus 104. The predetermined action selection screen identifies the decision for which the predetermined action is to be selected by way of a code 116. Each decision which requires a user input (such as that presented by dialogue box 113 in FIG. 3) is assigned a code which unique identifies that decision. The code 116 is also shown as part of a header of the dialogue box 113 shown in FIG. 3. This enables a user of the data processing apparatus 104 to identify the decision for which the predetermined action is being selected. The screen provides a plurality of selectable options each being for selection of a respective one of the plurality of predetermined actions.

In the example of FIG. 4, there are four selectable options each corresponding to a respective one of the above-described first, second, third and fourth actions. Each option is selectable by way of a virtual button. The first virtual button 402 represents the first action of automatically selecting the “No” option. The second virtual button 403 represents the second action of recommending (but not automatically selecting) the “No” option. The third virtual button 404 represents the third action of recommending (but not automatically selecting) the “Yes” option. The fourth virtual button 405 represents the fourth action of automatically selecting the “Yes” option. The user selects a suitable one of the first, second, third and fourth actions by selecting the appropriate virtual button 40. Once the desired button has been selected, the user then confirms the selection by selecting the “confirm” virtual button 406. In this case, the user may select the virtual buttons by way of a suitable device (such as a computer mouse or touch screen, for example) which is able to input commands to the processor 105 of the data processing apparatus 104 via the communication circuitry 107. Information indicative of the selected predetermined action is then stored in the storage medium 201 as part of an electronic file and is transmitted to the data processing device 100 where it is stored in the storage medium 200. When the processor 101 of the data processing device 100 determines that a decision is to be made (for example, the decision indicated by dialogue box 113), the processor 101 looks up the decision (via the decision code) and retrieves the information indicative of the predetermined action. The processor then executes the indicated predetermined action. It is noted that the decision codes which uniquely identify each respective decision that may require an input from the user are not limited to use with the data processing apparatus 104 when it is operated by a service provider. In general, each of the decisions may be associated with a unique identifier (such as a code or the like) so as to enable efficient lookup of an indicated action for a particular decision by the processor 101.

In an embodiment, for a given decision, information indicative of one or more indicated actions associated with that decision may be stored in the storage medium 202 of the data processing apparatus 108.

For example, when the data processing device 104 is an end-user data processing device 104, information indicative of each action indicated in response to a particular decision (such as the selection of a “Yes” or “No” option, as previously described) may be transmitted (along with an identifier of that decision) to the data processing apparatus 108. This information is then stored as action information in the storage medium 202. In another example, when the data processing device 104 is controlled by a service provider, information indicative of the predetermined action selected at the data processing device 104 for execution by the data processing device 100 in response to a particular decision (such as the first, second, third or fourth actions mentioned above) may be transmitted (along with an identifier of that decision) to the data processing apparatus 108. This information is then stored as action information in the storage medium 202.

When the same decision must later on be made at the data processing apparatus 100, the processor 101 controls the communication circuitry 103 to transmit a request to the data processing apparatus 108 to request the action information stored in the storage medium 202 for that particular decision (the request may include the unique identifier of the decision, for example). In response, the processor 109 of the data processing apparatus 103 looks up the action information for the decision identified in the request and controls the communication circuitry 110 to transmit the action information to the data processing apparatus 100. The processor 101 is then able to execute the appropriate predetermined action based on the action information. The action information may also comprise a value of a predetermined parameter, as will be explained.

When the data processing device 104 is controlled by a service provider which monitors the most appropriate predetermined action to be taken for each decision, the user of the data processing device 100 is able to have a high confidence in the predetermined action taken. Typically, this will be because the service provider employs professional users to, for example, monitor online threats and the like and to thus make an informed decision on the most appropriate predetermined action to be taken for each decision. The indicated predetermined action for each decision is also updatable at the data processing device 104 (for example, using the same interface as exemplified with reference to FIG. 4 for updating a particular decision) so that, for example, if external security conditions change (for example, if there is a reported online security breach), a different predetermined action may be selected and indicated to the data processing apparatus 100 for a particular decision (for example, a recommended “Yes” could be changed to a recommended “No” or even an automatic “No” in light of a particular reported security breach).

On the other hand, when the indicated action on the basis of which the one of the plurality of predetermined actions is to be determined and executed is indicated by the user of the data processing apparatus 100 itself or by an end-user of a data processing apparatus 104, there is no guarantee that such end-users (who, unlike a professional user employed by a service provider, may not have sufficient knowledge of online threats, for example) will indicate appropriate actions. There is therefore a risk that, if an action indicated by all users of the data processing apparatus 100 or another data processing apparatus 104 in response to previous instances of a decision is used in determining a predetermined action to be executed in response to a new instance of the decision at the data process apparatus 100, then the determined predetermined action may not be appropriate.

Thus, in an embodiment, only users with a predetermined level of competence may indicate actions executable in response to the decision to be made in the way as described. The level of competence of a particular user may be determined in any suitable way.

In one example, a user is determined as having the predetermined level of competence for a particular decision to be made if it is known that they have accessed an advanced menu or the like associated with that decision. This is because users with technical knowledge relating to the decision to be made are more likely to access an advanced menu or the like than users without such technical knowledge. Information indicating an indicated action of the user in response to a particular decision to be made is then only recorded and used for determining the one of the plurality of predetermined actions at the data processing apparatus 100 if the user accesses an advanced menu or the like when making that decision. For example, looking again at FIG. 3, if a user of the data processing devices 100 or 104 is presented with the dialogue box 113, then they may be determined as a user with the predetermined level of competence if they select the “Advanced” virtual button 114C. Only if the “Advanced” virtual button 114C is selected by the user is the user determined to have the predetermined level of competence. When the user is determined to have the predetermined level of competence, the selection of “Yes” or “No” is recorded as information indicative of the selected action of the user and is used in determining the predetermined action to be executed by the data processing apparatus 100. If the user is not determined to have the predetermined level of competence (because they did not select the “Advanced” virtual button 114C), the “Yes” or “No” option selected by the user is not recorded or used in determining the predetermined action to be executed by the data processing apparatus 100. Thus, only advanced users are able to influence the one of the plurality of predetermined actions to be carried out at the data processing device 100.

In a more specific example, in order to prevent a user who accidently presses the “Advanced” virtual button 114C from being incorrectly deemed a user having the predetermined level of confidence, a user is only determined to have the predetermined level of confidence if they make and save changes using an advanced menu or the like accessed by pressing the “Advanced” virtual button 114C. In this case, if a user presses the “Advanced” virtual button 114C but then does not make and save any changes enabled by pressing the “Advanced” virtual button, the user is not determined to have the predetermined level of competence.

In another example, a user must register with the service provider in order for that user to be determined as having the predetermined level of competence. During the registration process, the user must demonstrate their integrity and their level of competence in order to become registered (by providing verifiable contact details and proof that they have been awarded a qualification approved by the service provider, for example). Indicated actions (such as the selection of “Yes” or “No” in the dialogue box 113 of FIG. 3) are then only recorded as part of action information in the storage medium 202 for registered users. It is ensured that only the indicated actions of registered users are stored as part of the action information in the storage medium 202 by, for example, assigning credential information to each registered user (such as a username and password) which is securely stored in the storage medium 202 and which must be provided by the user in order for information indicative of indicated actions of the user to be transmitted to the data processing apparatus 108 and stored in the storage medium 202. In other words, a registered user of a data processing apparatus 100 or 104 must remotely log in to the data processing apparatus 108 in order for indicated actions of the user to be used in determining the one of the plurality of predetermined actions to be executed at the data processing apparatus 100. The need for users to be registered in this way helps alleviate the possibility of an organised malicious attack in which, for example, multiple users of data processing apparatuses 104 deliberately choose an inappropriate option (for example, selecting “Yes” in the dialogue box 113 of FIG. 3 when it is not actually safe to do so) in order to artificially affect which of the plurality of predetermined actions is executed by the data processing apparatus 100.

In another example, if the data processing device 100 and one or more data processing devices 104 are part of a local network only containing trusted devices (such as a Local Area Network (LAN)), then credential information from each of the data processing devices 104 does not need to be entered in order for indicated actions by the users of those data processing devices 104 to be used in determining the one of the plurality of predetermined actions to be executed at the data processing apparatus 100. This is because the data processing device 100 and one or more data processing devices 104 are trusted devices. A user of the local network may also select only a portion of the one or more data processing devices 104 to provide information indicative of an indicated action executable in response to the decision to be made at the data processing device 100 for determining the one of the plurality of predetermined actions to be executed by the data processing device 100 by individually configuring each data processing device 104 (for example, by selecting a “Yes” or “No” option for sharing information indicating the action indicated by the user for each decision presented at the data processing device 104 with other data processing devices on the local network). In one embodiment, the user may configure only one of the data processing devices 104 as being suitable for sharing information indicating the action indicated by the user for each decision presented at the data processing device 104 with the data processing apparatus 100. In this case, the configured one of the data processing devices 104 may transmit the information indicative of the indicated action directly to the data processing device 100 and the processor 101 of the data processing device 100 may simply copy the action indicated at the configured data processing device 104. For example, if a user of the configured data processing devices 104 selects “Yes” when presented with the dialogue box 113 shown in FIG. 3, then when the same decision needs to be made at the data processing device 100, the processor 101 automatically selects the “Yes” option. Such an arrangement is useful, for example, if the configured data processing device 104 is operated by a system administrator of the network (with suitable technical knowledge) and when the data processing device 100 is operated by an end-user without technical knowledge.

As previously explained, in an embodiment, for a given decision, information indicative of one or more indicated actions associated with that decision (as previously indicated at the data processing apparatus 100 and/or at one or more other data processing apparatuses 104) may be stored in the storage medium 202 of the data processing apparatus 108. This information is stored as action information. For example, when the data processing device 104 is an end-user data processing device 104, information indicative of each action indicated in response to a particular decision (such as the selection of a “Yes” or “No” option, as previously described) may be transmitted (along with an identifier of that decision) to the data processing apparatus 108. This information is then stored as action information in the storage medium 202. In another example, when the data processing device 104 is controlled by a service provider, information indicative of the predetermined action selected at the data processing device 104 for execution by the data processing device 100 in response to a particular decision (such as the first, second, third or fourth actions mentioned above) may be transmitted (along with an identifier of that decision) to the data processing apparatus 108. This information is then stored as action information in the storage medium 202.

This action information is then used by the processor 101 of the data processing apparatus 100 in order to determine the predetermined action to be taken in response to a new instance of the given decision which needs to be made at the data processing apparatus 100.

In an embodiment, the action information is used to generate a value of a predetermined parameter. The value of the predetermined parameter is then used by the processor 101 in order to determine the one of the plurality of predetermined actions to take. The value of the predetermined parameter may be determined by the processor 109 of the data processing apparatus 108 based on the action and transmitted to the data processing apparatus 100 via the communication circuitry 110, for example. In another example, the action information itself is transmitted from the data processing apparatus 108 to the data processing apparatus 100, and the processor 101 of the data processing apparatus 100 determines the value of the predetermined parameter.

In an embodiment, the plurality of predetermined actions comprises the second action (for example, recommended (but not automatic) selection of the “No” option in FIG. 3) and the third action (for example, recommended (but not automatic) selection of the “Yes” option in FIG. 3). In response to determining that a decision is to be made, the processor 101 is configured to determine and to execute the second action when a value of the predetermined parameter is less than a first predetermined threshold (threshold 1) and to determine and to execute the third action when the value of the predetermined parameter is greater than the first predetermined threshold. In an extension of this embodiment, the plurality of predetermined actions also comprises the first action (for example, automatic selection of the “No” option in FIG. 3) and the fourth action (for example, automatic selection of the “Yes” option in FIG. 3). In response to determining that the decision is to be made, the processor 105 is configured to determine and to execute the first action when the value of the predetermined parameter is less than a second predetermined threshold (threshold 2), the second predetermined threshold being less than the first predetermined threshold, and to determine and to execute the fourth action when the value of the predetermined parameter is greater than a third predetermined threshold (threshold 3), the third predetermined threshold being greater than the first predetermined threshold.

Such an arrangement is summarised in Table 1. In this case, the value of the predetermined parameter is denoted “x”.

TABLE 1

| Parameter value “x” | Selected predetermined action |
|---|---|
| x < threshold 2 | First action |
| threshold 2 < x < threshold 1 | Second action |
| threshold 1 < x < threshold 3 | Third action |
| x > threshold 3 | Fourth action |

The value of the parameter may be determined in any suitable way.

For example, when one or more data processing devices 104 are end-user type devices, the value of the parameter may be increased or decreased in relation to the number of selections of each of first and second options made in response to a given decision being presented at each of the data processing device 104. For example, in the case that the first and second options are, respectively, selection of “No” and selection of “Yes” in the decision to be made shown in FIG. 3, then each time “No” is selected at a data processing device 104, the value of the parameter is reduced by a predetermined amount (for example, an absolute amount or a percentage amount), and each time “Yes” is selected at a data processing device 104, the value of the parameter is increased by a predetermined amount (for example, an absolute amount or a percentage amount).

In another example, when there is a data processing device 104 operated by a service provider or network administrator (for example) which directly determines the predetermined action to be taken (as exemplified in FIG. 4), the value of the predetermined parameter may be changed to a predetermined value in response to the selected predetermined action. For example, if the first action is selected (by selecting virtual button 402 in FIG. 4, for example), then a predetermined value of the parameter which is known to be less than “threshold 2” will be determined. If the second action is selected (by selecting virtual button 403 in FIG. 4, for example), then a predetermined value of the parameter which is known to be greater than “threshold 2” but less than “threshold 1” will be determined. If the third action is selected (by selecting virtual button 404 in FIG. 4, for example), then a predetermined value of the parameter which is known to be greater than “threshold 1” but less than “threshold 3” will be determined. If the fourth action is selected (by selecting virtual button 405 in FIG. 4, for example), then a predetermined value of the parameter which is known to be greater than “threshold 3” will be determined.

In both instances, the predetermined action taken at the data processing device 100 in response to a new instance of the decision to be made at the data processing device 100 is thus adjusted depending on previous decisions made at one or more other data processing devices 104.

In an embodiment, it is possible that there is both an end-user operated data processing apparatus 104 and a service provider or system administrator operated data processing apparatus 104. In this case, for example, the processor 109 of the data processing apparatus 108 prioritises the action information from the service provider or system administrator operated data processing apparatus 104.

In an embodiment, as well as the value of the predetermined parameter being adjusted in dependence on the decisions made at one or more data processing apparatuses 104, the predetermined parameter and/or one or more of the thresholds (that is, thresholds 1, threshold 2 and/or threshold 3) may also be adjusted in dependence on one or more other factors. In such a case, for example, the data processing device 100 may receive an initial value of the predetermined parameter as determined at the data processing apparatus 108. Depending on the one or more other factors, the initial value of the predetermined parameter and/or one or more of the thresholds may then be adjusted.

In one example, a factor is a security characteristic associated with an activity comprising the exchange of information between the data processing apparatus 100 and other entities of a network (such an activity may be referred to as an “online activity”). Such an activity may include browsing websites, for example. Some websites require greater security considerations than others. For example, browsing an information website such as “Wikipedia” will generally require less consideration of security risks than accessing a banking website for conducting online banking.

For websites with a greater need for consideration of security risks, the initial value of the predetermined parameter received from the data processing apparatus 108 may be reduced (for example, by multiplying the initial parameter value by a weighting value which is less than 1, the weighting value being smaller the greater the security risk). Alternatively or in addition, the thresholds 1 and/or 2 may be increased (for example, by multiplying threshold 1 and/or threshold 2 by respective weighting values which are greater than 1, the weighting value being larger the greater the security risk). On the other hand, for websites with a lesser need for consideration of security risks, the initial value of the predetermined parameter received from the data processing apparatus 108 may be increased (for example, by multiplying the initial parameter value by a weighting value which is greater than 1, the weighting value being larger the lesser the security risk). Alternatively, the thresholds 1 and/or 2 may be reduced (for example, by multiplying threshold 1 and/or threshold 2 by respective weighting values which less than than 1, the weighting value being smaller the lesser the security risk).

Such arrangements serve to appropriately bias the predetermined action taken by the data processing apparatus 100 in response to a particular decision in accordance with security risks associated with a particular online activity. Thus, to use the example of FIG. 3, such arrangements serve to make it more likely to that “No” will be selected (by automatic selection and/or recommendation) when conducting a higher risk online activity such as online banking, thus providing improved protection for the user from online security risks. On the other hand, it is more likely that “Yes” will be selected (by automatic selection and/or recommendation) when conducting a lower risk online activity such as browsing “Wikipedia”, thus providing reduced interruption of the user experience.

In embodiments, online activities which may be carried out by the user (such as accessing of different websites or web services) may each be associated with one or more respective weighting values for multiplying an initial value of the predetermined parameter and/or one or more of the thresholds (depending on the security risk associated with each online activity, for example). The one or more respective weighting values for each online activity may be stored in a storage medium of a data processing apparatus such as data processing apparatus 108 and transmitted to the data processing apparatus 100 on request, for example (the data processing apparatus may transmit such a request when it first initiates a particular online activity such as accessing a particular website, for example). The one or more respective weighting values for each online activity stored in the may updated by a service provider, network administrator or the like.

It will be appreciated that other factors may be used to adjust the initial value of the predetermined parameter and/or one or more of the thresholds instead of or in addition to the above described security characteristics of a particular online activity. For example, another factor is a level of competence of the user of the data processing apparatus 100.

For less competent users (that is, users with less technical knowledge for making an informed decision when dialogue boxes such as dialogue box 113 are displayed), the thresholds 2 and 3 may be brought closer together so that the relationship threshold 2=threshold 1=threshold 3 is approached (for example, by applying a weighting which is greater than 1 to the value of threshold 2 and applying a weighting which is less than 1 to the value of threshold 3). This has the effect of increasing the proportion of decisions which are likely to result in the execution of an automatic option selection (for example, the first action in which “No” is automatically selected or the fourth action in which “Yes” is automatically selected in FIG. 3) rather than the execution of recommended option selection (for example, the second action in which “No” is recommended or the third action in which “Yes” is recommended in FIG. 3). Less competent users are therefore interrupted by the need to make a decision less often, thereby improving the user experience.

On the other hand, for more competent users (that is, users with more technical knowledge for making an informed decision when dialogue boxes such as dialogue box 113 are displayed), the thresholds 2 and 3 may be taken further apart from each other so that the relationship threshold 2<<threshold 1<<threshold 3 is approached (for example, by a weighting which is less than 1 to the value of threshold 2 and applying a weighting which is greater than 1 to the value of threshold 3). This has the effect of reducing the proportion of decisions which are likely to result in the execution of an automatic option selection (for example, the first action in which “No” is automatically selected or the fourth action in which “Yes” is automatically selected in FIG. 3) rather than the execution of recommended option selection (for example, the second action in which “No” is recommended or the third action in which “Yes” is recommended in FIG. 3). More competent users are therefore more often able to make their own decisions with regards to decisions to be made, since they have the competence in order to make such informed decisions.

The competence of a user may be selected by the user using a menu system or the like (not shown) accessed via the user interface 103 of the data processing apparatus 100. For example, upon setup of the data processing apparatus 103, the user may be presented with a multiple choice menu with the options “Novice”, “Intermediate” or “Advanced” user. Upon selection of one of these options, one or more weightings for adjusting the threshold values are determined accordingly. For example, for a “Novice” user, a weighting to be applied to the value of threshold 2 which is greater than 1 and a weighting to be applied to the value of threshold 3 which is less than 1 is determined. For an “Intermediate” user, the values of the thresholds remain unchanged (that is, they remain at their default values). For an “Advanced” user, a weighting to be applied to the value of threshold 2 which is less than 1 and a weighting to be applied to the value of threshold 3 which is greater than 1 is determined.

In the above-mentioned embodiments, default values of each of threshold 1, threshold 2 and threshold 3 may be stored in the storage medium 200 of the data processing apparatus 100 in advance. These default values may then be adjusted, where appropriate, according to the above-mentioned weightings. Although specific examples of the ways in which the thresholds may be adjusted have been given, it will be appreciated that the present disclosure is not limited to such examples. In other examples, depending on, for example, the security characteristics associated with a particular online activity or the level of competence of a user, the thresholds may be adjusted in different ways.

One example includes applying a weighting to the value of threshold 2 such that the relationship threshold 2=threshold 1 is approached whilst leaving the values of threshold 1 and threshold 3 unchanged (thus essentially ensuring that only the first action (e.g. automatic selection of “No”), third action (e.g. recommended selection of “Yes”) and fourth action (e.g. automatic selection of “Yes”)) are executable). Such a weighting could be used with the example of FIG. 3 for less competent users, for example, such that, when the value of the predetermined parameter is less than the value of threshold 1, the first option of automatically selecting “No” is always carried out. Such an arrangement leads to increased security for less competent users, since the option of making a decision which, based on the value of the predetermined parameter, is not recommended, is taken away.

Another example includes applying a weighting to the value of threshold 3 such that the relationship threshold 3=threshold 1 is approached whilst leaving the values of threshold 1 and threshold 2 unchanged (thus essentially ensuring that only the first action (e.g. automatic selection of “No”), second action (e.g. recommended selection of “No”) and fourth action (e.g. automatic selection of “Yes”) are selectable). Such a weighting could be used with the example of FIG. 3 such that, when the value of the predetermined parameter is greater than the value of threshold 1, the fourth option of automatically selecting “Yes” is always carried out. Such an arrangement leads to an improved user experience, since a user is not interrupted with a dialogue box such as dialogue box 113 in FIG. 3 when the recommendation is that a particular action is safe to carry out.

It will thus be appreciated that the use of adjustable thresholds allows a subset of a given plurality of predetermined executable actions to be selected based on one or more factors (such as user competence and a security characteristic of a particular online activity) known at the time of having to make a particular decision at the data processing apparatus 100.

As previously described, the second action may further comprise determining whether the user has selected one of the plurality of predetermined selectable options within a first predetermined time period and, when the user has not selected one of the plurality of predetermined selectable options with the first predetermined time period, selecting the first one of the plurality of predetermined selectable options in order to make the decision to be made. For example, in the embodiment of FIG. 3, the recommended “No” option may be automatically selected in the case that the user does not select either “Yes”, “No” or “Advanced” within the first predetermined time period. Similarly, the third action may further comprise determining whether the user has selected one of the plurality of predetermined selectable options within a second predetermined time period and, when the user has not selected one of the plurality of predetermined selectable options with the second predetermined time period, selecting the second one of the plurality of predetermined selectable options in order to make the decision to be made. For example, in the embodiment of FIG. 3, the recommended “Yes” option may be automatically selected in the case that the user does not select either “Yes”, “No” or “Advanced” within the second predetermined time period.

In such an embodiment, the first and/or second predetermined time periods may be adjusted depending on the value of the predetermined parameter. For example, in the case that the above-described thresholds are used, the first predetermined time period (after which the “No” option is automatically selected as the recommended option in FIG. 3) may be adjusted to be smaller as the value of the predetermined parameter approaches threshold 2. At the point at which the predetermined parameter reaches threshold 2, the first predetermined time period is reduced to zero (at which point, the second action in which “No” is recommended becomes the first action in which “No” is automatically selected). In another example, the second predetermined time period (after which the “Yes” option is automatically selected as the recommended option in FIG. 3) may be adjusted to be smaller as the value of the predetermined parameter approaches threshold 3. At the point at which the predetermined parameter reaches threshold 2, the second predetermined time period is reduced to zero (at which point, the third action in which “Yes” is recommended becomes the fourth action in which “Yes” is automatically selected). Such an arrangement serves to reduce the time for which a user's experience is interrupted depending on the extent to which the selection of particular option (based on the value of the predetermined parameter) is recommended.

In light of the above description, it will be appreciated that embodiments of the present disclosure help to provide an improved balance between protecting a user from security risks and reducing the interruption of the user experience relating to the need for technical decisions to be made when operating a data processing apparatus (such as, for example, a personal computer, televisions, mobile phone, tablet computer, games console or the like).

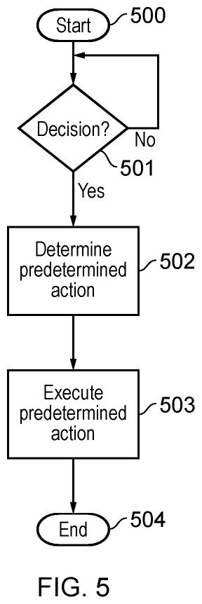

FIG. 5 shows a flow chart illustrating a method of operating the data processing apparatus 100 according to an embodiment. Such a method may be implemented by the processor 101, for example. The method starts at step 500. At step 501, it is determined whether a decision associated with a process executable by the data processing apparatus 100 is to be made. In response to not determining that a decision is to be made, the process returns to step 501. On the other hand, in response to determining that the decision is to be made, the process proceeds to step 502, in which one of a plurality of predetermined actions is determined to be executed based on a previously indicated action executable in response to the decision to be made by a user at the data processing apparatus 100 or at one or more other data processing apparatuses (for example, data processing apparatus 104) connected to the data processing apparatus 100. At step 503, the determined predetermined action is executed. The method then ends at step 504.

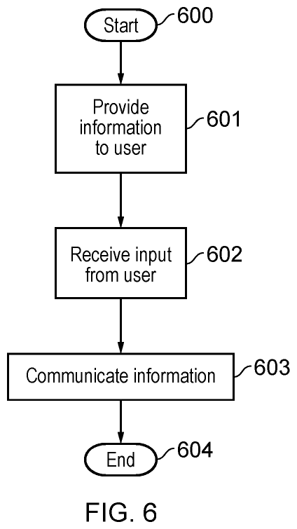

FIG. 6 shows a flow chart illustrating a method of operating the data processing apparatus 104 according to an embodiment. Such a method may be implemented by the processor 105, for example. The method starts at step 600. At step 601, the user interface circuitry 106 of the data processing apparatus 104 (which is a first data processing apparatus) is controlled to provide information to a user indicative of a decision to be made, the decision being associated with a process executable at a second data processing apparatus (for example, the data processing apparatus 100). At step 602, the user interface circuitry 106 is controlled to receive an input from the user indicative of an action executable in response to the decision to be made. At step 603, the communication circuitry 107 of the data processing apparatus 104 is controlled to communicate information indicative of the indicated action to a third data processing apparatus (for example, the data processing apparatus 108) for use by the second data processing apparatus in determining one of a plurality of predetermined actions to be executed in response to it being determined by the second data processing apparatus that the decision associated with the process executable by the second data processing apparatus is to be made. The method then ends at step 604.

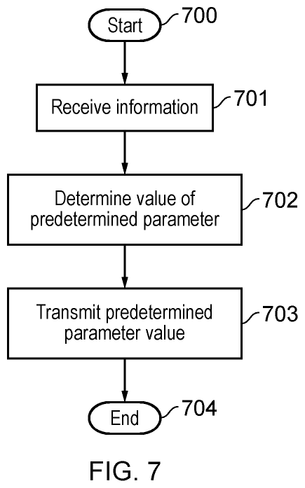

FIG. 7 shows a flow chart illustrating a method of operating the data processing apparatus 108 according to an embodiment. Such a method may be implemented by the processor 109, for example. The method starts at step 700. At step 701, the communication circuitry 110 of the data processing apparatus 108 (which is a first data processing apparatus) is controlled to receive, from one or more second data processing apparatuses (for example, data processing apparatus 104), information indicative of an action executable in response to a decision to be made, the decision being associated with a process executable at a third data processing apparatus (for example, data processing apparatus 100). At step 702, based on the received information from each of the one or more second data processing apparatuses, a value of a predetermined parameter is determined. At step 703, the communication circuitry 110 is controlled to transmit information indicative of the value of the predetermined parameter to the third data processing apparatus for use by the third data processing apparatus in determining one of a plurality of predetermined actions to be executed in response to it being determined by the third data processing apparatus that the decision associated with the process executable by the third data processing apparatus is to be made. The method then ends at step 704.

It will be appreciated that various features of the above-described embodiments may be selected and combined in any suitable combination so as to provide improved user security and a better user experience for a given type of decision, application, user or the like. An example is now given below to demonstrate such a selection and combination.

In this example, on a 1^{st} day (Day 1), a user of data processing apparatus 104 is shown a dialogue box reading “There is a problem with this certificate. Do you want to continue?”. “Yes”, “No” and “Advanced” options are given.

The user selects the “Advanced” option, which display further information about the certificate. For example, the further information reads “This certificate appears to be self-signed”. The options “Yes” and “No” remain. There may also be a further option “?” (which is displayed because the “Advanced” option has been selected) which, when selected, gives a long and detailed technical explanation of the issue. The user then eventually selects either “Yes” or “No” (perhaps after consulting the technical details displayed upon selection of “?”).

The decision is then made at the data processing apparatus 104. Furthermore, because the user selected the “Advanced” option, the selected “Yes” or “No” option is able to influence the recommended and/or automatic decisions for that same issue when displayed by another device such as data processing apparatus 100. Such decisions may influence a data processing device 100 on the same local network (for example, a data processing apparatus in the same home or office) or may influence a wider number of devices (for example, over the internet) by affecting the value of a predetermined parameter stored at another data processing device 108 which is consulted by the data processing device 100 when a decision needs to be made. In this example, the options selected at the data processing device 104 are used to influence the value of a parameter for the issue at hand stored at the data processing device 108. The user selects “No” on Day 1 because they consider the security risk to be too high.

At a later date (e.g. on the 5^{th} day, Day 5), other learning input has occurred. In particular, the general opinion of “Advanced” users is that the security risk is not as high as originally thought. A significant number of advanced users of data processing devices 104 have therefore selected “Yes”, thus influencing the value of the parameter stored at the data processing device 104 to favour “Yes”. When the decision needs to be made at a data processing device 100, the “Yes” option is therefore recommended.

At a later date (e.g. on the 10^{th} day, Day 10), further learning input has occurred, with an even larger number of “Advanced” users at data processing devices 104 having selected the “Yes” option. The value of the parameter is now such that “Yes” is selected automatically at each data processing device 100. Users at these devices therefore do not even have to make a decision. The safe decision is made automatically for them, thus providing a non-interrupted user experience.

At a later date (e.g. on the 20^{th} day, Day 20), it is determined (e.g. by customer feedback or by security community information) that the service to which the security certificate relates has been hacked and that it is no longer safe to accept the certificate. A system administrator in control of the data processing apparatus 108 thus manually changes the action to be carried out by each data processing apparatus 100 to be to recommended that “No” is selected. Furthermore, information may be provided to the user of a data processing apparatus 100 explaining why “No” is now recommended (e.g. the information could be “There is a problem with this certificate. The service is possibly compromised”).

At a later date (e.g. on the 21^{st} day, Day 21), conclusive evidence that a hack took place may have been confirmed. The system administrator thus manually changes the action to be carried out by each data processing apparatus 100 to be that “No” is automatically selected. This protects the users of the data processing apparatuses 100 from the security risks associated with the hack.

Embodiments of the present technique are defined by the following numbered clauses:

1. A data processing apparatus comprising processor circuitry, the processor circuitry being configured:
to determine whether a decision associated with a process executable by the processor circuitry is to be made;
in response to determining that the decision is to be made, to determine one of a plurality of predetermined actions to be executed based on a previously indicated action executable in response to the decision to be made at the data processing apparatus or at one or more other data processing apparatuses connected to the data processing apparatus; and
to execute the determined predetermined action.

2. A data processing apparatus according to clause 1, wherein the plurality of predetermined actions comprises one or more of:
a first action of selecting a first one of a plurality of predetermined selectable options in order to make the decision to be made;
a second action of indicating that the first one of the plurality of selectable options is recommended for selection in order to make the decision to be made;
a third action of indicating that a second one of the plurality of selectable options is recommended for selection in order to make the decision to be made; and
a fourth action of selecting the second one of the plurality of predetermined selectable options in order to make the decision to be made.

3. A data processing apparatus according to clause 2 comprising user interface circuitry, wherein:
the second action comprises controlling the user interface circuitry to output information indicative of the decision to be made and to output information indicating that the first one of the plurality of selectable options is recommended for selection; and
the third action comprises controlling the user interface circuitry to output information indicative of the decision to be made and to output information indicating that the second one of the plurality of selectable options is recommended for selection.

4. A data processing apparatus according to clause 3 comprising a display, wherein:
the second action comprises controlling the display to display the information indicative of the decision to be made and information indicative of the plurality of selectable options such that the first one of the plurality of selectable options recommended for selection is visually distinguishable from the other ones of the plurality of selectable options; and
the third action comprises controlling the display to display the information indicative of the decision to be made and information indicative of the plurality of selectable options such that the second one of the plurality of selectable options recommended for selection is visually distinguishable from the other ones of the plurality of selectable options.

5. A data processing apparatus according to any one of clauses 2 to 4, wherein:
the second action comprises determining whether selection of one of the plurality of predetermined selectable options within a first predetermined time period has occurred and, when selection of one of the plurality of predetermined selectable options with the first predetermined time period has not occurred, selecting the first one of the plurality of predetermined selectable options in order to make the decision to be made; or
the third action comprises determining whether selection of one of the plurality of predetermined selectable options within a second predetermined time period has occurred and, when selection of one of the plurality of predetermined selectable options with the second predetermined time period has not occurred, selecting the second one of the plurality of predetermined selectable options in order to make the decision to be made.

6. A data processing apparatus according to any one of clauses 2 to 5, wherein:
the one of the plurality of predetermined actions is determined based on a predetermined parameter which is variable based on the previously indicated action executable in response to the decision to be made at the data processing apparatus or at one or more other data processing apparatuses connected to the data processing apparatus;
the plurality of predetermined actions comprises the second action and the third action; and
in response to determining that the decision is to be made, the processor circuitry is configured to determine and to execute the second action when a value of the predetermined parameter is less than a first predetermined threshold and to determine and to execute the third action when the value of the predetermined parameter is greater than the first predetermined threshold.

A data processing apparatus according to clause 6, wherein:
the plurality of predetermined actions comprises the first action;
in response to determining that the decision is to be made, the processor circuitry is configured to determine and to execute the first action when the value of the predetermined parameter is less than a second predetermined threshold, the second predetermined threshold being less than the first predetermined threshold

8. A data processing apparatus according to clause 6 or 7, wherein:
the plurality of predetermined actions comprises the fourth action;
in response to determining that the decision is to be made, the processor circuitry is configured to determine and to execute the fourth action when the value of the predetermined parameter is greater than a third predetermined threshold, the third predetermined threshold being greater than the first predetermined threshold.

9. A data processing apparatus according to any one of clauses 6 to 8, comprising communication circuitry configured to receive the value of the predetermined parameter from another data processing apparatus.

10. A data processing apparatus according to any preceding clause, wherein the one of the plurality of predetermined actions is determined based on a security characteristic associated with an activity undertaken using the data processing apparatus comprising the exchange of information between the data processing apparatus and another data processing apparatus.

11. A data processing apparatus according to any preceding clause, wherein the one of the plurality of predetermined actions is determined based on a level of competence of a user of the data processing apparatus.

12. A data processing apparatus according to any preceding clause, wherein the action executable in response to the decision to be made is indicated by selection of one of a plurality of predetermined selectable options output by one of the one or more other data processing apparatuses in order to make the decision to be made at the one of the one or more other data processing apparatuses.

13. A data processing apparatus according to clause 12, wherein a user of the one of the one or more other data processing apparatuses is a user with a predetermined level of competence.

14. A data processing apparatus according to clause 12 or 13, wherein the one of the one or more other data processing apparatuses is connected to the data processing apparatus via a local network.

15. A first data processing apparatus comprising processor circuitry, user interface circuitry and communication circuitry, wherein:
the processor circuitry is configured to control the user interface circuitry to output information indicative of a decision to be made, the decision being associated with a process executable at a second data processing apparatus;
the user interface circuitry is configured to receive an input indicative of an action executable in response to the decision to be made; and
the communication circuitry is configured to communicate information indicative of the indicated action to a third data processing apparatus for use by the second data processing apparatus in determining one of a plurality of predetermined actions to be executed in response to it being determined by the second data processing apparatus that the decision associated with the process executable by the second data processing apparatus is to be made.

16. A first data processing apparatus according to clause 15, wherein the second and third data processes apparatuses are the same data processing apparatus.

17. A first data processing apparatus according to clause 15 or 16, wherein the user interface circuitry is configured to output a plurality of predetermined selectable options for making the decision to be made at the first data processing apparatus and to receive, as the input, a selection of one of the plurality of predetermined selectable options.

18. A first data processing apparatus according to clause 17, wherein a user of the first data processing apparatus is a user with a predetermined level of competence.

19. A first data processing apparatus according to clause 17 or 18, wherein the one of the one or more other data processing apparatuses is connected to the second data processing apparatus via a local network.

20. A first data processing apparatus comprising processor circuitry and communication circuitry, wherein:
the communication circuitry is configured to receive, from one or more second data processing apparatuses, information indicative of an action executable in response to a decision to be made, the decision being associated with a process executable at a third data processing apparatus;
the processor circuitry is configured to determine, based on the received information from each of the one or more second data processing apparatuses, a value of a predetermined parameter; and
the communication circuitry is configured to transmit information indicative of the value of the predetermined parameter to the third data processing apparatus for use by the third data processing apparatus in determining one of a plurality of predetermined actions to be executed in response to it being determined by the third data processing apparatus that the decision associated with the process executable by the third data processing apparatus is to be made.

21. A system comprising a data processing apparatus according to clause 1, a data processing apparatus according to clause 15 and a data processing apparatus according to clause 20.

22. A method of operating a data processing apparatus, the method comprising:
determining whether a decision associated with a process executable by the data processing apparatus is to be made;
in response to determining that the decision is to be made, determining one of a plurality of predetermined actions to be executed based on a previously indicated action executable in response to the decision to be made at the data processing apparatus or at one or more other data processing apparatuses connected to the data processing apparatus; and
executing the determined predetermined action.

23. A method of operating a first data processing apparatus, the method comprising:
controlling user interface circuitry of the first data processing apparatus to output information indicative of a decision to be made, the decision being associated with a process executable at a second data processing apparatus;
controlling the user interface circuitry to receive an input indicative of an action executable in response to the decision to be made; and
controlling communication circuitry of the first data processing apparatus to communicate information indicative of the indicated action to a third data processing apparatus for use by the second data processing apparatus in determining one of a plurality of predetermined actions to be executed in response to it being determined by the second data processing apparatus that the decision associated with the process executable by the second data processing apparatus is to be made.

24. A method of operating a first data processing apparatus, the method comprising:
controlling communication circuitry of the first data processing apparatus to receive, from one or more second data processing apparatuses, information indicative of an action executable in response to a decision to be made, the decision being associated with a process executable at a third data processing apparatus;
determining, based on the received information from each of the one or more second data processing apparatuses, a value of a predetermined parameter; and
controlling the communication circuitry to transmit information indicative of the value of the predetermined parameter to the third data processing apparatus for use by the third data processing apparatus in determining one of a plurality of predetermined actions to be executed in response to it being determined by the third data processing apparatus that the decision associated with the process executable by the third data processing apparatus is to be made.

25. A non-transitory computer readable medium including computer program instructions, which when executed by a computer causes the computer to perform the method of clauses 22 to 24.

Numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

1. A data processing apparatus comprising processor circuitry, the processor circuitry being configured:
to determine whether a decision associated with a process executable by the processor circuitry is to be made;
in response to determining that the decision is to be made, to determine one of a plurality of predetermined actions to be executed based on a previously indicated action executable in response to the decision to be made at the data processing apparatus or at one or more other data processing apparatuses connected to the data processing apparatus; and
to execute the determined predetermined action;
wherein the plurality of predetermined actions comprises one or more of:
a first action of selecting a first one of a plurality of predetermined selectable options in order to make the decision to be made;
a second action of indicating that the first one of the plurality of selectable options is recommended for selection in order to make the decision to be made;
a third action of indicating that a second one of the plurality of selectable options is recommended for selection in order to make the decision to be made; and
a fourth action of selecting the second one of the plurality of predetermined selectable options in order to make the decision to be made; and wherein:
the one of the plurality of predetermined actions is determined based on a predetermined parameter which is variable based on the previously indicated action executable in response to the decision to be made at the data processing apparatus or at one or more other data processing apparatuses connected to the data processing apparatus;
the plurality of predetermined actions comprises the second action and the third action; and
in response to determining that the decision is to be made, the processor circuitry is configured to determine and to execute the second action when a value of the predetermined parameter is less than a first predetermined threshold and to determine and to execute the third action when the value of the predetermined parameter is greater than the first predetermined threshold.

2. A data processing apparatus according to claim 1 comprising user interface circuitry, wherein:
the second action comprises controlling the user interface circuitry to output information indicative of the decision to be made and to output information indicating that the first one of the plurality of selectable options is recommended for selection; and
the third action comprises controlling the user interface circuitry to output information indicative of the decision to be made and to output information indicating that the second one of the plurality of selectable options is recommended for selection.

3. A data processing apparatus according to claim 2 comprising a display,
wherein:
the second action comprises controlling the display to display the information indicative of the decision to be made and information indicative of the plurality of selectable options such that the first one of the plurality of selectable options recommended for selection is visually distinguishable from the other ones of the plurality of selectable options; and
the third action comprises controlling the display to display the information indicative of the decision to be made and information indicative of the plurality of selectable options such that the second one of the plurality of selectable options recommended for selection is visually distinguishable from the other ones of the plurality of selectable options.

4. A data processing apparatus according to claim 1, wherein:
the second action comprises determining whether selection of one of the plurality of predetermined selectable options within a first predetermined time period has occurred and, when selection of one of the plurality of predetermined selectable options with the first predetermined time period has not occurred, selecting the first one of the plurality of predetermined selectable options in order to make the decision to be made; or
the third action comprises determining whether selection of one of the plurality of predetermined selectable options within a second predetermined time period has occurred and, when selection of one of the plurality of predetermined selectable options with the second predetermined time period has not occurred, selecting the second one of the plurality of predetermined selectable options in order to make the decision to be made.

5. A data processing apparatus according to claim 1, wherein:
the plurality of predetermined actions comprises the first action;
in response to determining that the decision is to be made, the processor circuitry is configured to determine and to execute the first action when the value of the predetermined parameter is less than a second predetermined threshold, the second predetermined threshold being less than the first predetermined threshold

6. A data processing apparatus according to claim 1, wherein:
the plurality of predetermined actions comprises the fourth action;
in response to determining that the decision is to be made, the processor circuitry is configured to determine and to execute the fourth action when the value of the predetermined parameter is greater than a third predetermined threshold, the third predetermined threshold being greater than the first predetermined threshold.

7. A data processing apparatus according to claim 1, comprising communication circuitry configured to receive the value of the predetermined parameter from another data processing apparatus.

8. A data processing apparatus according to claim 1, wherein the one of the plurality of predetermined actions is determined based on a security characteristic associated with an activity undertaken using the data processing apparatus comprising the exchange of information between the data processing apparatus and another data processing apparatus.

9. A data processing apparatus according to claim 1, wherein the one of the plurality of predetermined actions is determined based on a level of competence of a user of the data processing apparatus.

10. A data processing apparatus according to claim 1, wherein the action executable in response to the decision to be made is indicated by selection of one of a plurality of predetermined selectable options output by one of the one or more other data processing apparatuses in order to make the decision to be made at the one of the one or more other data processing apparatuses.

11. A data processing apparatus according to claim 10, wherein a user of the one of the one or more other data processing apparatuses is a user with a predetermined level of competence.

12. A data processing apparatus according to claim 10, wherein the one of the one or more other data processing apparatuses is connected to the data processing apparatus via a local network.

13. A first data processing apparatus comprising processor circuitry and communication circuitry, wherein:
the communication circuitry is configured to receive, from one or more second data processing apparatuses, information indicative of an action executable in response to a decision to be made, the decision being associated with a process executable at a third data processing apparatus;
the processor circuitry is configured to determine, based on the received information from each of the one or more second data processing apparatuses, a value of a predetermined parameter; and
the communication circuitry is configured to transmit information indicative of the value of the predetermined parameter to the third data processing apparatus for use by the third data processing apparatus in determining one of a plurality of predetermined actions to be executed in response to it being determined by the third data processing apparatus that the decision associated with the process executable by the third data processing apparatus is to be made;
wherein the plurality of predetermined actions comprises one or more of:
a first action of indicating that the first one of the plurality of selectable options is recommended for selection in order to make the decision to be made; and
a second action of indicating that a second one of the plurality of selectable options is recommended for selection in order to make the decision to be made; and wherein
the third data processing apparatus is configured to determine and to execute the first action when a value of the predetermined parameter is less than a first predetermined threshold and to determine and to execute the second action when the value of the predetermined parameter is greater than the first predetermined threshold.

14. A system comprising a data processing apparatus according to claim 1.

15. A method of operating a data processing apparatus, the method comprising:
determining whether a decision associated with a process executable by the data processing apparatus is to be made;
in response to determining that the decision is to be made, determining one of a plurality of predetermined actions to be executed based on a previously indicated action executable in response to the decision to be made at the data processing apparatus or at one or more other data processing apparatuses connected to the data processing apparatus; and
executing the determined predetermined action;
wherein the plurality of predetermined actions comprises one or more of:
a first action of selecting a first one of a plurality of predetermined selectable options in order to make the decision to be made;
a second action of indicating that the first one of the plurality of selectable options is recommended for selection in order to make the decision to be made;
a third action of indicating that a second one of the plurality of selectable options is recommended for selection in order to make the decision to be made; and
a fourth action of selecting the second one of the plurality of predetermined selectable options in order to make the decision to be made; and wherein:
the one of the plurality of predetermined actions is determined based on a predetermined parameter which is variable based on the previously indicated action executable in response to the decision to be made at the data processing apparatus or at one or more other data processing apparatuses connected to the data processing apparatus;
the plurality of predetermined actions comprises the second action and the third action; and
the method comprises, in response to determining that the decision is to be made, determining and to executing the second action when a value of the predetermined parameter is less than a first predetermined threshold and determining and executing the third action when the value of the predetermined parameter is greater than the first predetermined threshold.

16. A method of operating a first data processing apparatus, the method comprising:
controlling communication circuitry of the first data processing apparatus to receive, from one or more second data processing apparatuses, information indicative of an action executable in response to a decision to be made, the decision being associated with a process executable at a third data processing apparatus;
determining, based on the received information from each of the one or more second data processing apparatuses, a value of a predetermined parameter; and
controlling the communication circuitry to transmit information indicative of the value of the predetermined parameter to the third data processing apparatus for use by the third data processing apparatus in determining one of a plurality of predetermined actions to be executed in response to it being determined by the third data processing apparatus that the decision associated with the process executable by the third data processing apparatus is to be made
wherein the plurality of predetermined actions comprises one or more of:
a first action of indicating that the first one of the plurality of selectable options is recommended for selection in order to make the decision to be made; and
a second action of indicating that a second one of the plurality of selectable options is recommended for selection in order to make the decision to be made; and wherein
the third data processing apparatus is configured to determine and to execute the first action when a value of the predetermined parameter is less than a first predetermined threshold and to determine and to execute the second action when the value of the predetermined parameter is greater than the first predetermined threshold.

17. A non-transitory computer readable medium including computer program instructions, which when executed by a computer causes the computer to perform the method of claim 15.
